(19) United States
(12) Patent Application Publication
(10) Pub. No.: US 2002/0077406 A1
(43) Pub. Date: Jun. 20, 2002

(54) Composition of polypropylene resin

(76) Inventors: Young-Hwan Yu, Ulsan (KR); In-Bok Kim, Daejon (KR); Jae-Rim Choi, Daejon (KR)

Correspondence Address: CHRISTIE, PARKER & HALE, LLP, P.O. BOX 7068, PASADENA, CA, 91109-7068, US

(21) Appl. No.: 10/004,214

(22) Filed: Oct. 24, 2001

(30) Foreign Application Priority Data
Nov. 1, 2000 (KR) 2000-64689

(51) Int. Cl. C08K 3/34

(52) U.S. Cl. 524/451

(57) ABSTRACT

The present invention relates to a polypropylene resin composition, more specifically to a polypropylene resin composition comprising ethylene-propylene block copolymer consisting of propylene polymer and ethylene-propylene copolymer with specific limit viscosity and content, ethylene-propylene copolymer rubber, ethylene a-olefin copolymer, inorganic filler, and polar group-consisting resin. It can be applied for peripheral automotive parts like crash pad without using adhesive because it has superior impact resistance and heat resistance, adhesion to urethane foam and forming contraction ratio comparable to that of ABS/PC resin.

### FIELD OF THE INVENTION

The present invention relates to a polypropylene resin composition, more specifically to a polypropylene resin composition comprising ethylene-propylene block copolymer consisting of propylene polymer and ethylene-propylene copolymer with specific limit viscosity and content, ethylene-propylene copolymer rubber, ethylene a-olefin copolymer, polar group-containing resin, and inorganic filler. This polypropylene resin composition can be applied for peripheral automotive parts like crash pad without using any adhesive because it is superior in impact resistance, heat resistance, adhesion to urethane foam and forming contraction ratio comparable to that of ABS/PC resin.

### BACKGROUND OF THE INVENTION

Although conventional polypropylene resin is fairly economical with its cost only about 30% that of ABS/PC resin, its physical properties are too poor to be used as highly functional automotive interior parts.

Recently, researches to replace automotive plastic parts made of engineering plastic, i.e. ABS/PC resin or ABS resin, with inexpensive polypropylene resin by improving its physical properties are being carried out actively worldwide.

However, although conventional polypropylene resin is inexpensive, it has many problems to replace ABS/PC resin in products like core part of soft-type crash pad (hereunder referred to as “C/pad”) or defroster nozzle cover.

For example, additional injection mold is required due to the large difference in forming contraction ratio and thus, it requires additional cost and manufacturing time which may take several months.

Also, the dimension of the product becomes poor due to high forming contraction ratio, and adhesive (primer) should be used between polypropylene resin and polyurethane foam because of its poor adhesion to polyurethane foam. Consequently, the cost reduction effect derived from replacing ABS/PC resin with polypropylene resin is offset. In terms of reclamation, the recycling cost becomes high and the physical properties of reclaimed products become poor.

Also, crack was observed in the product in real vehicle crash tests performed related with approvals of North America and Europe due to the weak impact resistance. Also, there occurs a problem of thermal deformation in the product.

Therefore, ABS/PC and ABS resin are used to make C/Pad core, defroster nozzle cover, side & CTR A/vent and side & CTR A/vent duct, which increases production cost and generates many problems such as chemical crack in air vent and worsening of recyclability of due to the use of different materials.

### SUMMARY OF THE INVENTION

Accordingly, an object of this invention is to provide polypropylene resin composition comprising ethylene-propylene block copolymer consisting of propylene polymer and ethylene- propylene copolymer with specific limit viscosity and content, ethylene-propylene copolymer rubber, ethylene a-olefin copolymer, polar group-containing resin, and inorganic filler in order to improve impact resistance, thermal deformation temperature, adhesion to polyurethane foam and recyclability, resolve chemical crack problems, and provide forming contraction ratio equivalent to or better than that of ABS/PC resin, so that it can be applied for peripheral automotive parts like air vent or air vent duct with low cost.

### DETAILED DESCRIPTION OF THE INVENTION

The present invention is characterized by a polypropylene resin composition comprising:

a) 50-80 wt. % of propylene homopolymer, ethylene-propylene block copolymer or a mixture thereof;

b) 5-20 wt. % of ethylene-propylene copolymer rubber;

c) 5-20 wt. % of ethylene a-olefin copolymer having an a-olefin content of 15-40 wt. %;

d) 1-15 wt. % of polar group-containing resin such as carboxy (—COOH), hydroxy (—OH), and cyano (—CN) group; and

e) 5-40 wt. % of an inorganic filler.

Hereunder is given a more detailed description of the present invention.

The polypropylene resin composition of the present invention is characterized by using ethylene-propylene block copolymer in the form of crystalline polymer consisting of propylene homopolymer and propylene-ethylene copolymer.

For said propylene homopolymer, the one with pentad fraction (% mmmm) measured by ¹³C-NMR higher than 96%, preferably higher than 96.5% and more preferentially higher than 97%, is used. If the pentad fraction is below 96%, the heat resistance is degraded. And further, said propylene homopolymer with limit viscosity [η] measured in 135° C. of decalin in the range of 0.7- 1.5 dL/g, preferably in the range of 1.5-1.4 dL/g and more preferably in the range of 0.9-1.3 dL/g, is used. If the limit viscosity [η] is below 0.7 dL/g, the impact resistance worsens; otherwise if it exceeds 1.5 dL/g, the formability worsens. Still further, the melt index of propylene homopolymer is in the range of 10-80 g/10 min, preferably in the range of 20-60 g/10 min. If the melt index is below 10 g/10 min, the formability worsens; otherwise if it exceeds 80 g/10 min, the impact resistance worsens.

For said ethylene-propylene block copolymer, the one with limit viscosity [η] measured in 135° C. of decalin in the range of 3.0-5.0 dL/g, preferably in the range of 3.5-5.0 dL/g and more preferably in the range of 4.0-4.5 dL/g, is used. If the limit viscosity [η] is below 3.0 dL/g, the impact resistance worsens.

Said propylene homopolymer may be used alone but it is more preferred to use ethylene-propylene block copolymer consisting of 70-100 wt. % of propylene homopolymer and 0-30 wt. % of ethylene-propylene copolymer since propylene homopolymer with poor impact resistance and ethylene-propylene copolymer with poor formability, rigidity and heat resistance may complement each other.

For the propylene homopolymer used in the formation of block copolymer, the one with melt index at 230° C. being 10-80 g/l0min, preferably 20-60 g/10 min, is used. If the melt index is below 10 g/l0min, the formability worsens; otherwise if it exceeds 80 g/10 min, the impact resistance worsens.

The ethylene-propylene block copolymer is used in 50-80 wt. % to the entire polypropylene resin composition, preferably in 55-75 wt. %. If the content exceeds 80 wt. %, the impact resistance is degraded; otherwise if it is below 50 wt. %, the formability is degraded.

As a second component of the polypropylene resin composition of the present invention, ethylene-propylene copolymer rubber (hereunder referred to as “EPR”) having a propylene content of 20-70 wt. %, preferably 40-60 wt. %, is used in 5-20 wt. %. If the propylene content is below 20 wt. %, the impact resistance worsens; otherwise if it exceeds 70 wt. %, the rigidity worsens. Also, if the EPR content is below 5 wt. %; the impact resistance is not expected to improve; otherwise if it exceeds 20 wt. %, the impact resistance worsens.

For the EPR, the one with melt index at 230° C. being 0.3-10 g/10 min, preferably 0.5-5 g/10 min, is used. If the melt index is below 0.3 g/10 min, the appearance and mechanical property worsen due to the poor dispersion; otherwise if it exceeds 10 g/10 min, the impact resistance worsens.

As a third component of the polypropylene resin composition of the present invention, ethylene a-olefin copolymer having a-olefin content of 15-40 wt. % is used in the range of 5-20 wt. % to the entire polypropylene resin composition.

In general, the ethylene a-olefin copolymer may be prepared from ethylene butene-1 copolymer (hereunder referred to as “EBM”) and ethylene/octene-1 copolymer (hereunder referred to as “EOM”) The EBM having a C₄ (butene) content of 12-25 wt. %, preferably 15-20 wt. % and the melt index of 0.5-10 g/10 min, preferably being 1-5 g/10 min, is used. Also, the EOM with the Mooney viscosity ML₁₊₄ (121° C.) being 1-50 dL/g, preferably being 1.5-35 dL/g, and the density being 0.86-0.91 g/cm³, is used.

As a fourth component of the polypropylene resin composition of the present invention, a polar group-containing resin selected from a carboxylic group (—COOH), a hydroxy group (—OH), and a cyano group (—CN) is used in the range of 1-15 wt. % to the entire polypropylene resin composition. If it is less than 1 wt. %, the adhesion to polyurethane is inferior; otherwise if it exceeds 15 wt. %, the impact resistance worsens.

The preferred polar group-containing resin is selected from the group consisting of a modified polypropylene with carboxylic acid graft ratio larger than 0.5 wt. %, acrylonitrile butadiene rubber having an acrylonitile content of 25-40 wt. %, polyolefin polyol having a viscosity of 10-16 poise, and a mixture thereof.

As the last component of the polypropylene resin composition of the present invention, an inorganic filler is used in 5-40 wt. %. If the content is below 5 wt. %, the rigidity and heat resistance worsen; otherwise if it exceeds 40 wt. %, the impact resistance worsens. For said inorganic filler, talc with average particle diameter smaller than 5 μm is used. If the average particle diameter exceeds 5 μm, the impact resistance and elongation become poor.

Besides talc, barium sulfate, calcium carbonate and wollastonite, with the average grain size in the range of 0.5- 10 μm, may be used as the inorganic filler.

In the polypropylene resin composition of the present invention, various additives that are common to the one in the art, such as antioxidant, neutralizer, adhesive resin and antistatic agent, can be used additionally, if necessary.

The method for preparing the polypropylene resin composition of the present invention is not limited to any special method, and it can be prepared by conventional mechanical mixing. To be specific, general melting mixers like Bambury mixer, single-axis extruder, double-axis extruder and multiwheel screw extruder can be used. The mixing temperature is recommended to be 170-240° C.

The forming method of the composition of the present invention is not limited to any special method; and extrusion forming, hollow forming, injection forming and sheet forming can be used. Among these, injection forming is the most suitable. Many pretreatment can be performed to improve the quality of automotive parts formed from these forming methods.

The polypropylene resin composition of the present invention described above has improved impact resistance and thermal deformation temperature to meet the requirements of C/Pad and SUB products; forming contraction ratio equivalent to or better than ABS/PC resin; and improved adhesion to polyurethane foam as to make additional injection mold unnecessary. Also, the dimensional stability is improved by the high forming contraction ratio of the polypropylene resin; the recyclability is enhanced by not using adhesives due to its good adhesion to polyurethane foam and by incorporating materials; the production cost is reduced by not using primer; and the chemical crack is improved fundamentally.

Hereunder is given a more detailed description of the present invention using examples. However, it should not be construed as limiting the scope of this invention.

### EXAMPLES 1-4 & COMPARATIVE EXAMPLES 1-9

Ethylene-propylene block copolymer (hereunder referred to as ‘A’), ethylene-propylene copolymer rubber (hereunder referred to as ‘B’), ethylene a-olefin copolymer (hereunder referred to as ‘C’), polar group-containing resin (hereunder referred to as ‘D’), and inorganic filler (hereunder referred to as ‘E’), with the composition and content as in Tables 1-3, were mixed as in Table 4 and dry-blended for 3 min. After mixing the mixture with a double-axis extruder (diameter: 45 mmΦ) set at 190° C., the polypropylene resin composition pellet was prepared. Each obtained resin composition pellet was prepared to test specimen using an injection forming machine set at 200° C.

TABLE 1

| | | | | Xylene | | | Average | |
|---|---|---|---|---|---|---|---|---|
| | | | Ethylene | Extract | Limit | Cohomomer | Particle | Content of |
| | | Melt index | Content | Content | Viscosity | Content | Diameter of | polar group |
| Items | | (g/10 min) | (wt. %) | (wt %) | (dL/g) | (wt. %) | Talc (μm) | (functionality) |
| (A) | PP-1 | 35 | 50 | 15 | 3.6 | — | | |
| | PP-2 | 25 | 50 | 14 | 2.7 | — | | |
| | PP-3 | 60 | 50 | 14 | 3.6 | — | | |
| | PP-4 | 60 | 60 | 15 | 4.3 | — | | |
| | PP-5 | 8 | 60 | 15 | 4.3 | — | | |
| (B) | EPR-1 | 3.2 | — | — | — | 72 | | |
| | EPR-2 | 0.5 | — | — | — | 35 | | |
| (C) | EBM-1 | 2.0 | — | — | — | 20 | | |
| | EOM-1 | 1.0 | — | — | — | 32 | | |
| | EOM-2 | 30 | — | — | — | 25 | | |
| (D) | MPP | | | | | | | 4.8 (—COOH) |
| | Polyol | | | | | | | 1.4 (—OH) |
| | NBR | | | | | | | 32 (—CN) |
| (E) | T-1 | — | — | — | — | | 2.9 | |
| | T-2 | — | — | — | — | | 7.6 | |

(A) PP Polyethylene-propylene block copolymer
(B) EPR: Ethylene-propylene copolymer rubber
(C) EBM: Ethylene butene-1 copolymer
EOM Ethylene octane-1 copolymer
(D) MPP. Carboxylic acid modified polypropylene
Polyol: Polylolefine polyol
NBR: Acrylonitrile butadiene rubber
(E) T: Talc

In Table 1, the melt index of the component (A) was measured with ASTM D1238 (230° C./2.16 kg) and its ethylene content was determined with FT-IR; and the cohomomer content of EPR of the component (B), and EBM or EOM of the component (C) were determined with FT-IR. The average particle diameter of talc (component (D)) as an inorganic filler was measured with laser sedimentation method. The graft ratio of MPP of the component (E) was determined with FT-IR.

TABLE 2

| | | Composition (wt. %) | | | | |
|---|---|---|---|---|---|---|
| Items | | A | B | C | D | E |
| Examples | 1 | PP-4:60 | EPR-1:10 | EOM-1:5 | MPP:3 | T-1:25 |
| | | | | | NBR:2 | |
| | 2 | PP-4:60 | EPR-2:10 | EOM-2:5 | MPP:3 | T-1:25 |
| | | | | | NBR:2 | |
| | 3 | PP-1:60 | EPR-1:10 | EOM-1:5 | MPP:3 | T-1:25 |
| | | | | | NBR:2 | |
| | 4 | PP-4:60 | EPR-1:10 | EOM-1:5 | MPP:2 | T-1:25 |
| | | | | | NBR:2 | |
| | | | | | Polyol:1 | |
| Comparative | 1 | PP-4:60 | EPR-1:10 | EOM-1:5 | MPP:3 | T-2:25 |
| Examples | | | | | NBR:2 | |
| | 2 | PP-2:60 | EPR-1:10 | EOM-1:5 | MPP:3 | T-2:25 |
| | | | | | NBR:2 | |
| | 3 | PP-3:60 | EPR-1:10 | EOM-1:5 | MPP:3 | T-1:25 |
| | | | | | NBR:2 | |
| | 4 | PP-5:60 | EPR-1:10 | EOM-1:5 | MPP:3 | T-1:25 |
| | | | | | NBR:2 | |
| | 5 | PP-4:60 | EPR-1:15 | — | MPP:3 | T-1:25 |
| | | | | | NBR:2 | |
| | 6 | PP-4:60 | EPR-2:15 | — | MPP:3 | T-1:25 |
| | | | | | NBR:2 | |
| | 7 | PP-4:60 | EPR-1:10 | EOM-1:5 | MPP:3 | T-1:25 |
| | | | | | NBR:2 | |
| | 8 | PP-4:65 | EPR-1:10 | EOM-1:5 | — | T-1:25 |
| | 9 | PP-4:60 | EPR-1:10 | EOM-2:5 | NBR:2 | T-1:25 |
| | | | | | Polyol:3 | |

(E) PP Polyethylene-propylene block copolymer
(F) EPR: Ethylene-propylene copolymer rubber
(G) EBM: Ethylene butene-1 copolymer
EOM Ethylene octane-1 copolymer
(H) MPP Carboxylic acid modified polypropylene
Polyol: Polylolefine polyol
NBR: Acrylonitrile butadiene rubber
(E) T Talc

### TESTING EXAMPLE: TEST OF PHYSICAL PROPERTIES

Physical properties of the polypropylene resin composition prepared from Examples 1-4 and Comparative Examples 1-9 were tested by the following method. The result is shown in Table 3.

[Test Method]

A. Melt index (MI, g/10 min): Tested with ASTM D1238 (230° C./2.16 kg)

B. Izod impact resistance (kg·cm/cm²): Tested with ASTM D256 at 23° C.

C. Modulus of bending elasticity (kg/cm²): Tested with ASTM D790A

D. Thermal deformation temperature (°C.): Tested with ASTM D648

E. Adhesion: After mixing MDI and polyol 2:1 in a beaker, the prepared polypropylene resin composition was formed to a 100 mm×200 mm×3 mm pellet by the time the reaction began. After pouring the mixture solution of MDI and polyol on the pellet, it was pressed with another test specimen for 1 hr. The distance between the test specimens (the thickness of urethane foam) was maintained at 5-7 mm. The area of remaining urethane foam on the test specimen while scraping it with uniform force at the speed of 100 mm/min was measured. If the remaining urethane foam area was larger than 1/3, O was given; otherwise if it is smaller than 1/3, X was given.

TABLE 3

| | | | | Modulus | Thermal | Adhesion |
|---|---|---|---|---|---|---|
| | | | Izod Impact | of bending | Deformation | to |
| | | Melt index | Resistance | Elasticity | Temperature | Urethane |
| Items | | (g/10 min) | (kg · cm/cm²) | (kg/cm²) | (° C.) | Foam |
| Examples | 1 | 22 | 24 | 24800 | 127 | ∘ |
| | 2 | 27 | 21 | 24400 | 125 | ∘ |
| | 3 | 18 | 21 | 25200 | 127 | ∘ |
| | 4 | 27 | 20 | 25500 | 127 | ∘ |
| Comparative | 1 | 23 | 16 | 25100 | 125 | ∘ |
| Examples | 2 | 20 | 12 | 24700 | 123 | ∘ |
| | 3 | 25 | 17 | 25500 | 126 | ∘ |
| | 4 | 7 | 32 | 26200 | 131 | ∘ |
| | 5 | 24 | 16 | 25600 | 127 | ∘ |
| | 6 | 14 | 28 | 23200 | 118 | ∘ |
| | 7 | 31 | 13 | 26300 | 129 | ∘ |
| | 8 | 37 | 12 | 27300 | 132 | X |
| | 9 | 34 | 15 | 23600 | 121 | X |

As shown in Table 3, the polypropylene resin composition of the present invention has superior impact resistance, rigidity and fluidity. In contrast, for Comparative Example 1, the impact resistance is inferior because of the use of talc having larger particle size; for Comparative Examples 2-3, the impact resistance is poor because of the low limit viscosity of xylene extract in the component (A); and for Comparative Example 4, the fluidity is poor because of the low melt index of said component (A). For Comparative Example 5, the impact resistance is poor due to the use of ethylene-propylene copolymer rubber (EPR) with small molecular weight; and for Comparative Example 6, the fluidity is poor due to the use of ethylene-propylene copolymer rubber (EPR) with too large molecular weight. For Comparative Example 7, the impact resistance is poor due to the use of EBM with low cohomomer content; for Comparative Example 8, the impact resistance is poor due to the increase of polypropylene content and further the adhesion to urethane form is deteriorated because of no use of polar group-containing resin; and for Comparative Example 9, the impact resistance is poor due to the use of EOM with small molecular weight and the adhesion to urethane form is also deteriorated because of no use of MPP as a polar group-containing resin.

As explained in detail above, the polypropylene resin composition of the present invention, comprising ethylene-propylene block copolymer, ethylene-propylene copolymer rubber, a-olefin copolymer, polar group-containing resin and inorganic filler satisfying specific conditions, has superior impact resistance and heat resistance, forming contraction ratio equivalent to or better than that of ABS/PC resin and improved adhesion to urethane foam, so that it is suitable to be used peripheral automotive parts like crash pad.

What is claimed is:

1. A polypropylene resin composition comprising:
(a) 50-80 wt. % of ethyLene-propylene block copolymer consisting of 70-100 wt. % of propylene polymer and 0-30 wt. % of ethylene-propylene copolymer;
(b) 5-20 wt. % of ethylene-propylene copolymer rubber;
(c) 5-20 wt. % of ethylene a-olefin copolymer having an a-olefin content of 15-40 wt. %;
(d) 1-15 wt. % of a resin having polar groups selected from the group consisting of —COOH, —OH, and —CN; and
(e) 5-40 wt. % of an inorganic filler.

2. The polypropylene resin according to claim 1, wherein said ethylene-propylene block copolymer has higher than 3.0 dL/g of limit viscosity [η].

3. The polypropylene resin according to claim 1, wherein said ethylene-propylene copolymer rubber has 0.3-10 g/10 min of melt index at 230° C.

4. The polypropylene resin according to claim 1, wherein said polar group-containing resin is selected from the group consisting of carboxylic acid modified polypropylene with the graft ratio larger than 0.5 wt% acrylonitrile butadiene rubber having an acrylonitile content of 25-40 wt. %, polyolefinpolyol having a viscosity of 10-16 poise at 100° C., and a mixture thereof.

5. The polypropylene resin according to claim 1, wherein said inorganic filler is talc with average particle diameter smaller than 5 μm.
